(19) United States
(12) Patent Application Publication
(10) Pub. No.: US 2020/0055291 A1
(43) Pub. Date: Feb. 20, 2020

(54) EDGE TRIM STRIP

(71) Applicant: SURTECO GMBH, Buttenwiesen (DE)

(72) Inventors: Martin OTTOW, Essen (DE); Markus HERMANNS, Gladbeck (DE); Christoph KREMER, Dorsten (DE)

(21) Appl. No.: 16/609,766

(22) PCT Filed: May 11, 2018
(86) PCT No.: PCT/EP2018/062254

§ 371 Date: Oct. 31, 2019

(30) Foreign Application Priority Data
May 12, 2017 (DE) 20 2017 102 859.3

(51) Int. Cl. B32B 27/08; B32B 27/40; B32B 27/30; B32B 27/32; B32B 27/18; A47B 96/20

(52) U.S. Cl. CPC B32B 27/08; B32B 27/40; B32B 27/302; B32B 27/32; B32B 2274/00; A47B 96/201; B32B 2270/00; B32B 2479/00; B32B 27/18

(57) ABSTRACT

The subject matter is an edge trim strip for covering a narrow edge of a panel workpiece, particularly a furniture panel, comprising at least one front-face cover layer and one hot-melt layer made of TPU-based thermoplastic for securing the edge trim strip to the panel workpiece. The edge strip is characterized in that the hot-melt layer is composed of a polymer mixture (polymer blend) consisting of at least one TPU polymer and at least one additional polymer having increased polarity relative to the TPU polymer.

The invention relates to an edge trim strip for covering a narrow edge of a panel workpiece, particularly a furniture panel, comprising at least one (front-face) base layer and one hot-melt layer (on the rear face on the cover layer) for securing the edge trim strip to the workpiece, the hot-melt layer being composed of TPU (thermoplastic) polyurethane-based thermoplastic material. The panel workpieces or furniture panels can be wood-based panels, in particular, such as chipboard, fiberboard, or the like, or even composite panels. They can be provided on one or both faces with surface coatings. In order to secure the edge trim strip to the narrow edge surface of the workpiece, the edge trim strip is for example melted, particularly using microwave radiation. Alternatively, however, the invention also includes the use of other radiation sources, particularly laser radiation. In addition, hot air can also be used. The cover layer is also referred to as a base layer, which is the front-face layer of the edge trim strip that is visible in the assembled state. The hot-melt layer with which the edge is (adhesively) secured to the workpiece during assembly is on the rear face of this base layer.

It is inherently known from practice to for example apply a hot-melt adhesive to the edge trim strip during or immediately before fastening them to narrow edge faces of furniture panels. Attachment is performed using so-called edge-banding machines. During such attachment of the edge trim strip to the narrow edges of furniture panels, one constant problem that exists is that a visible gap can occur between the cover strips and the furniture panels or their narrow edges.

To avoid the hot-melt adhesive joints described, which are particularly visible during use or cleaning, it has been proposed to completely dispense with a hot-melt adhesive. An adhesive-free connection between a cover strip or plastic edge and a furniture panel is thus known from EP 1 163 864 in which the plastic edge is joined to the furniture board directly and without adhesive. To achieve this, the surface of the plastic edge is melted by laser radiation, thus resulting in a laser welding connection of an adhesive-free plastic edge to the furniture panel.

Alternatively, EP 1 852 242 proposes the use of a cover strip with a hot melt adhesive layer applied to one face of the cover strip, the cover strip having the hot-melt adhesive layer being produced by coextrusion. The hot-melt adhesive layer preferably has the same color as the cover strip, so that the cover strip can be secured to a furniture panel without a visible adhesive joint. The hot-melt adhesive or the hot-melt adhesive layer can be melted or activated by laser radiation. The cover strip can made of ABS, for example, and the hot-melt adhesive layer can be based on EVA, CoPa, or TPU.

WO 2009/026977 [U.S. Pat. No. 8,603,610] proposes an edge trim strip with a hot-melt layer that contains both polar and nonpolar components in its molecular structure. The hot-melt layer can be provided with laser-absorbing additives. The energy for melting the hot-melt layer can be supplied in the form of laser light, hot air, microwaves, ultrasound, etc. In one embodiment, the edge trim strip or structural layer consists of polypropylene, and the hot-melt layer consists of a graft copolymer, preferably maleic anhydride-grafted polypropylene. One alternative that is proposed is a hot-melt layer of (thermoplastic) polyurethane in a structural layer of ABS.

Moreover, EP 2 366 540 describes an edge trim strip made of thermoplastic material in a multilayer structure, particularly for furniture panels, that is characterized in that it has a highly fluent hot-melt layer in the molten state that has a hardness and melting temperature comparable to that of at least one other layer, which means that the edge trim strip overall should have a constant hardness and melting temperature. The edge trim strip is to be composed of a single-colored or through-colored thermoplastic material that comprises, in particular, polymers and copolymers of styrene, polyolefins, polycarbonates, polyesters, a polymer based on acrylates or vinyl chloride.

WO 2016/005337 [US 2017/0130099] discloses an edge trim strip of the above-described type in which the hot-melt layer has a dielectric loss factor for microwave radiation that is to be greater than the dielectric loss factor of the base layer. As a result, this edge trim strip is especially well suitable for activation and hence melting by microwave radiation. The hot-melt layer is composed of at least one thermoplastic polymer, for example from the group of the polystyrenes (for example ABS), polyvinyl chlorides (for example PVC-U), polypropylenes (PP), polyethylenes (PE), polyamides (PA), thermoplastic polyolefin-based elastomers or styrene block copolymers, thermoplastic copolyesters, thermoplastic copolyamides or thermoplastic polymethacrylates, thermoplastic polyurethanes, vinyl acetate-ethylene copolymers, methacrylate, and ethylene copolymers. Preferably, the hot-melt layer is provided with additives for increasing the dielectric loss factor. These can be electrically conductive particles or particles with an electrically conductive coating, for example mineral particles with a antimony-doped tin oxide layer.

DE 10 2013 022 086 [U.S. Pat. No. 10,442,131] describes an edge trim strip with a hot-melt layer, with the hot-melt layer comprising a thermoplastic polyolefin, specifically a readily flowing polyolefin. Preferably, the hot-melt layer is to be a combination of readily flowing polyolefins.

In addition, EP 2 653 513 [U.S. Pat. No. 9,321,244] describes a bonding method in which an edge band is coated by an adhesive layer that can be activated by laser radiation, to which layer an absorbent additive (laser additive), particularly a pigment, is added. The adhesive layer that can be activated by laser radiation is obtained starting from a dispersion or solution of at least one adhesive polymer.

Therefore, a general need exists for edge trim strips for the covering a narrow edge of a panel workpiece, particularly a furniture panel, to be made available that are provided with a hot-melt layer or functional layer that can be melted by suitable sources, such as by microwave radiation or laser radiation, for example, and pressed into permanent bond with the workpiece. In practice, the focus was on edge trim strips for activation by laser radiation during the development of the first embodiments. In the meantime, the use of microwave radiation (or, alternatively, hot air) has increasingly gained importance. In addition, a practical demand exists not only for PP edge trims with suitable functional layers, but increasingly also for other materials, such as ABS edge trims that are provided with TPU-based functional layers, for example, and can be activated by microwave radiation (see WO 2016/0905337). The described concepts have proven effective, but they could benefit from further development. This is where the invention comes in.

It is the object of the invention to provide an edge trim strip for the covering a narrow edge of a panel workpiece of the above-described type that can be manufactured economically and worked to a high quality.

To achieve this object, the invention teaches for a generic edge trim strip of the above-described type that the hot-melt layer of a polymer mixture (and hence polymer blend) consists of at least one TPU polymer and at least one additional polymer having increased polarity relative to the TPU polymer.

The invention proceeds in this regard from the insight that edge trim strips can be manufactured economically and have good processability, such TPU functional layers being used, for example, for ABS edges and edges with an ABS cover layer. Furthermore, the invention is based on the discovery that such edge trim strips with TPU-based functional layer have outstanding melting properties and hence processability not only with laser radiation, but also with microwave radiation in particular. The invention thus follows the considerations of WO 2016/005337. Processing with hot air is also possible.

On this basis, the invention has recognized that processing can be further optimized if the hot-melt layer does not consist (only) of a TPU polymer and optionally corresponding additives, but rather of a polymer blend based on TPU, with at least one additional polymer being added to the TPU polymer that has an increased polarity relative to the TPU polymer. This can be a styrene polymer, particularly a styrene copolymer. A styrene maleic anhydride copolymer is especially preferably used as an additional polymer. Such a copolymer is also referred to as SMA or SMAH.

Blending the TPU polymer with such an additive polymer improves the functionality in a number of ways. To wit, due to the increased polar nature of the additional polymer, the connection to the panel workpiece, particularly to a wood-based material, is improved on the one hand. On the other hand, increasing the polarity leads to an improvement in the activatability of the hot-melt layer by radiation and in particular by microwave radiation.

In practice, experiments with TPU functional coatings have shown that particularly good bonding properties are achieved with a soft TPU, but that the possibilities of reworking the edge trim strip after attachment to the furniture panel are limited. Although these options for secondary processing can be improved by hard TPU layers, this comes at the expense of adhesivity. According to the invention, a relatively hard TPU polymer can now be used, and the mixing with the additional polymer makes it possible to improve the bonding properties without having to accept disadvantages with regard to secondary processing.

What is more, the use of the described additional polymer as a styrene polymer, for example a styrene copolymer, not only results in good adhesion to a wood-based material, but also to a good adhesion to the cover layer or base layer, particularly if it is made of ABS or is ABS-based. The additional polymer results in better material compatibility of hot-melt layer on the one hand and cover layer on the other hand, and this leads in particular to improved processing and manufacturing, including for example in the coextrusion of the edge trim strip. For example, if a styrene polymer is used as an additional polymer, this results in better compatibility with a cover layer that is based on styrene or contains styrene, for example, a cover layer that is made of ABS. An edge trim strip is therefore especially preferably provided whose cover layer is made of ABS and whose functional layer consists of the described polymer mixture. In an alternative embodiment, however, a cover layer of other material such as PP, for example, can also be used.

As described above, an embodiment in which the additional polymer is a styrene polymer such as SMA, for example, has special importance. In addition, the polymer mixture can also have another polymer, preferably an ethylene methacrylate (EMA), in addition to the TPU polymer and the additional polymer, for example styrene polymer (for example SMA). The invention thus preferably comprises a polymer mixture of TPU and SMA on the one hand and a polymer mixture of TPU and SMA as well as EMA on the other hand. Other characteristics of the hot-melt layer and/or edge trim strip can be positively influenced by the additional polymer, for example EMA. For instance, the addition of EMA can improve compatibility with an adhesion promoter that can be optionally applied.

The edge trim strip according to the invention can be activated by laser radiation, for example, in which case the hot-melt layer is melted during processing with laser radiation and the edge trim strip is fastened to the workpiece. Alternatively, however, activation or melting using other radiation sources or types of radiation, such as hot air or plasma radiation, for example, can also be employed.

Furthermore, microwave radiation can be used during processing, meaning that the hot-melt layer can be melted by microwave radiation. In the context of the invention, the term “microwave radiation” refers to electromagnetic radiation having a frequency of from 300 MHZ to 300 GHz that is generated for example by a magnetron. Preferably, microwave radiation having a frequency of from 902 MHZ to 928 MHZ, for example 905 MHZ, or microwave radiation having a frequency of from 2.4 GHz to 2.5 GHz, for example 2.45 GHz, or microwave radiation having a frequency of from 5.7 GHz to 5.9 GHz, for example 5.8 GHz, is used.

The hot-melt layer has a dielectric loss factor for microwave radiation that is greater than the dielectric loss factor of the base layer. Recourse can therefore be had in this respect to the insights of WO 2016/005337. To this end, the hot-melt layer can be provided with additives for increasing the dielectric loss factor. These additives can be electrically conductive particles such as for example carbon black, metal particles, or other particles such as for example mineral particles having an electrically conductive coating. The coating can for example be an antimony-doped tin oxide layer. Such additives are distributed by Merck under the product name Iriotec, for example (for example Iriotec 7315, 7310, or 7320).

The invention exploits the consideration here that the activatability by microwave radiation (or also laser radiation) can be fundamentally improved aby the use of such additives. However, it was recognized according to the invention that the inventive hot-melt layer of the described polymer mixture having increased polarity already enables improved absorption of the microwaves, so that the addition of such an additive can be reduced (substantially). The reduction of special additives has the advantage that possible discoloration can be reduced or prevented by such additives. It also lies within the scope of the invention to completely dispense with such additives.

The edge trim strip according to the invention, which consists of at least the cover layer or base layer and the hot-melt layer, can be manufactured through coextrusion or aftercoating or post-coextrusion. At the same time, an adhesion promoter layer between the base layer and the hot-melt layer is preferably dispensed with. In addition, the invention also encompasses embodiments in which additional layers or possibly also a plurality of hot-melt layers are provided in addition to the hot-melt layer.

The proportion of the additional polymer (for example SMA) in the polymer mixture is, for example, 2 to 20 wt %, preferably 3 to 10 wt %, for example about 3 to 7 wt %. The proportion the additional polymer (for example EMA) that is optionally used in the polymer mixture can, for example, be 2 to 20 wt %, preferably 3 to 10 wt %, for example 3 to 7 wt %. For instance, the polymer mixture can contain 80 to 94 wt % TPU and 3 to 10 wt % SMA and 3 to 10 wt % EMA, for example 90 wt % TPU and 5 wt % SMA and 5 wt % EMA.

Insofar as an additive for optimizing the activatability by microwave radiation and/or laser radiation is used, the proportion of the additive in the hot-melt layer is for example 0.5 to 10 wt %, preferably 0.5 to 5 wt %.

The activatability and hence the melting of the hot-melt layer by microwave radiation (or, alternatively, also laser radiation or hot air) is of particular importance in the context of the invention. The invention thus also relates to the use of such an edge trim strip for attachment to a workpiece, particularly a furniture panel, the hot-melt layer being melted by microwave radiation, laser radiation, or hot air.

1. An edge trim strip for covering a narrow edge of a panel workpiece, comprising:
a front-face cover layer and
a hot-melt layer made of TPU-based thermoplastic for securing the edge trim strip to the panel workpiece, the hot-melt layer being composed of a polymer mixture (polymer blend) consisting of at least one thermoplastic polyurethane polymer and at least one additional polymer having increased polarity relative to the thermoplastic polyurethane polymer.

2. The edge trim strip according to claim 1, wherein the additional polymer is a styrene polymer, particularly a styrene copolymer.

3. The edge trim strip according to claim 2, wherein the additional polymer is a styrene maleic anhydride copolymer.

4. The edge trim strip according to claim 1, wherein the proportion of the additional polymer in the polymer mixture is 2 to 20 wt %.

5. The edge trim strip according to claim 1, wherein, in addition to the additional polymer having increased polarity, the polymer mixture contains another additional polymer.

6. The edge trim strip according to claim 5, wherein the proportion of the other additional polymer in the polymer mixture is 2 to 20 wt %.

7. The edge trim strip according to claim 1, wherein the cover layer is composed of acrylonitrile butadiene styrene or polypropylene.

8. The edge trim strip according to claim 1, wherein the hot-melt layer can be melted by microwave radiation, laser radiation, or hot air.

9. The edge trim strip according to claim 8, wherein the hot-melt layer is provided with at least one additive for increasing activation by microwave radiation or laser radiation.

10. A furniture panel comprising the edge trim strip secured to a narrow edge face according to claim 1.

11. The furniture panel according to claim 10, wherein the hot-melt layer is melted by microwave radiation, laser radiation, or hot air.

12. The edge trim according to claim 5, wherein the other additional polymer is ethylene methacrylate.
